(19) United States
(12) Patent Application Publication
(10) Pub. No.: US 2006/0150023 A1
(43) Pub. Date: Jul. 6, 2006

(54) Debugging apparatus

(75) Inventors: Tomoya Hasebe, Takatuki-shi (JP); Shinya Miyaji, Nara-shi (JP); Kazuhide Watanabe, Osaka-shi (JP)

Correspondence Address: MCDERMOTT WILL & EMERY LLP, 600 13TH STREET, N.W., WASHINGTON, DC, 20005-3096, US

(73) Assignee: Matsushita Electric Industrial Co., Ltd.

(21) Appl. No.: 11/297,387

(22) Filed: Dec. 9, 2005

(30) Foreign Application Priority Data
Dec. 10, 2004 (JP) P2004-358753

(51) Int. Cl. G06F 11/00

(52) U.S. Cl. 714/38

(57) ABSTRACT

To efficiently debug while reducing a debugging circuit in a system LSI made up of a plurality of CPUs.

A debugging apparatus includes debug object selection means 109 for selecting the CPU to be debugged from CPUs 11 and 12 in accordance with a debug object selection request from a host PC 15 connected to a system LSI 17, event information output means 110 for outputting internal event information of one selected CPU to be debugged, detected event storage means 106 for temporarily storing a detected event set by the host PC 15, and event comparison means 105 for making a comparison between the internal event information output from the event information output means 110 and the detected event stored in the detected event storage means 106 to detect a match therebetween. The event comparison means 105 notifies the host PC 15 that an event match is detected.

### BACKGROUND OF THE INVENTION

1. Field of the Invention

This invention relates to a debugging apparatus of a test program in a system LSI made up of a plurality of CPUs.

2. Description of the Related Art

Hitherto, some system LSIs each containing a CPU have included each a debugging circuit for performing operation trace and control of the CPU to efficiently debug a program.

In a system LSI made up of a plurality of CPUs, a debugging circuit is attached to each of the CPUs for debugging the CPU. (For example, refer to JP-A-9-244919)

In a debugging method described in patent document 1, each of a plurality of CPUs connected via a bus is provided with a debugging circuit for making it possible to conduct CPU-to-CPU communications for one CPU to give an instruction for starting or interrupting another CPU and for receiving an instruction for starting or interrupting the debugger of one CPU from another CPU.

Generally known debugging circuits include an event detection circuit for detecting an event preset by an externally connected host computer, a trace circuit for tracing the internal operation state of a CPU and storing the state in trace memory and then transferring the state to a host computer, a direct memory access circuit for accessing memory of a CPU from a host computer, etc.

In a system LSI made up of a plurality of CPUs, if debugging circuits are provided in a one-to-one correspondence with all CPUs in the method in the related art, as many debugging circuits as the number of the CPUs become necessary. Particularly, the area of the trace memory required for debugging is large and thus if as many trace memories as the number of the CPUs are installed, the whole area is largely affected.

Even in the system LSI made up of a plurality of CPUs, if the CPUs do not operate in a dense coordinated fashion, it is not necessary to operate the debugging circuits in a coordinated fashion for debugging as in patent document 1 and therefore it is useless to provide the debugging circuits in a one-to-one correspondence with all CPUs.

### SUMMARY OF THE INVENTION

It is an object of the invention to provide a debugging apparatus for making it possible to efficiently debug while reducing the whole debugging circuitry in a system LSI made up of a plurality of CPUs.

According to the invention, there is provided a debugging apparatus for transmitting and receiving debug data to and from a host computer connected to a system LSI including a plurality of CPUs and a plurality of storage means connected to the CPUs, the debugging apparatus including debug object selection means being capable of selecting the CPU to be debugged from among the CPUs in accordance with a debug object selection request transmitted from the host computer and stopping any other CPU not to be debugged than the CPU to be debugged and debugging means for debugging the CPU to be debugged in accordance with debug data transmitted from the host computer and transmitting the debug result to the host computer.

According to the described configuration, even in the system made up of a plurality of CPUs, only the CPU to be debugged, selected from the host computer can be debugged, so that debugging is made possible without providing debugging circuits in a one-to-one correspondence with all CPUs and it is made possible to reduce the debugging circuit resources.

In the invention, the debugging means includes a plurality of event information output means being connected to the CPUs for outputting internal event information of the CPU to be debugged, a plurality of CPU identifier output means being connected to the CPUs each for outputting a CPU identifier of the CPU, detected event storage means for temporarily storing a detected event set by the host computer, detected event CPU identifier storage means for storing a detected event CPU identifier set by the host computer, detected event CPU identifier comparison means for making a comparison between the CPU identifier and the detected event CPU identifier to detect a match therebetween, and event comparison means for making a comparison between the internal event information of the CPU indicated by the CPU identifier when the detected event CPU identifier comparison means detects a match and the detected event to detect a match therebetween.

According to the described configuration, a plurality of CPUs to be debugged, selected by the host computer output event information and CPU identifiers and the host computer can set the event to be detected and the CPU identifier to be detected. Thus, a comparison is made between the CPU identifier and the detected event set by the host computer and the CPU identifier and the detected event output from the CPU to be debugged and a check is made to ensure that they match, whereby event detection can be conducted and the CPU identifier is added to the event information and therefore if a plurality of CPUs to be debugged exist, it is made possible to reduce the number of event detection circuits to one.

In the invention, the debugging means includes event information output means being connected to all CPUs for outputting internal event information of one selected CPU to be debugged, detected event storage means for temporarily storing a detected event set by the host computer, and event comparison means for making a comparison between the internal event information and the detected event to detect a match therebetween.

According to the described configuration, the event comparison means makes a comparison between only the internal event information of one CPU to be debugged, selected by the debug object selection means and the detected event, so that it is made possible to reduce the number of detection circuits to one, and the area of the system LSI can be reduced. Since CPU identification information need not be set, it is made possible to reduce the communication amount from the host computer at the setting time.

In the invention, the debugging means further includes detected event group storage means, if the detected events set by the host computer are a plurality of sequential detected events, the detected event group storage means for storing the detected events exceeding the capacity of the detected event storage means in the storage means connected to the CPU not to be debugged in the execution order, detected event transfer means for transferring the detected events in the execution order from the detected event group stored in the storage means connected to the CPU not to be debugged to the detected event storage means if the event comparison means detects a match, and a detected event counter for counting the number of matches detected by the event comparison means and if the detected events set by the host computer are all detected, notifying the host computer that event detection is complete.

According to the described configuration, to conduct a plurality of sequential detected events, a plurality of pieces of event information are previously stored in the storage means of the CPU not to be debugged, whereby it becomes unnecessary to transfer event information to be detected from the host computer each time event detection is conducted. Since it also becomes unnecessary to wait for transfer from the host computer having low transfer speed each time event detection is conducted, the debugging efficiency can be improved. Further, as storage of the detected event, the storage means of the CPU not to be debugged is used rather than new additional storage means, whereby the debugging efficiency can be improved without increasing the number of debugging circuits.

In the invention, the debugging means includes a plurality of event information output means being connected to the CPUs for outputting internal event information of the CPU to be debugged, trace memory for storing the internal operation trace data of the CPU to be debugged, trace data storage means for generating the internal operation trace data from the internal event information and storing the internal operation trace data in the trace memory as the trace memory is divided into areas in the CPU units, trace data output means for outputting the internal operation trace data stored in the trace memory to the host computer, trace memory management means for managing a free space of the trace memory, and debug CPU control means for controlling temporary stop and operation restart of the CPU to be debugged in response to the free space of the trace memory.

According to the described configuration, the trace memory is divided into areas in a one-to-one correspondence with the CPUs to be debugged and the internal operation trace information can be stored in the areas corresponding to the CPUs and if the free space of the trace memory is out, the CPU is stopped and the trace data in the trace memory can be transferred to the host computer for each area, so that it is made possible to trace a plurality of CPUs even with one trace memory and the trace memory can be shared and thus the area of the system LSI can be reduced.

In the invention, the debugging means includes event information output means being connected to all CPUs for outputting internal event information of one selected CPU to be debugged, trace memory for storing the internal operation trace data of the CPU to be debugged, trace data storage means for generating the internal operation trace data from the internal event information and storing the internal operation trace data in the trace memory as the trace memory is divided into areas in the CPU units, trace data output means for outputting the internal operation trace data stored in the trace memory to the host computer, trace memory management means for managing a free space of the trace memory, and debug CPU control means for controlling temporary stop and operation restart of the CPU to be debugged in response to the free space of the trace memory.

According to the described configuration, even if a plurality of CPUs operate, only trace information of one CPU selected by the debug object selection means is output and is stored in the trace memory. As the CPU to be debugged is selected, it is made possible for one trace circuit to trace even in the system made up of a plurality of CPUs, and it is made possible to reduce the area of the system LSI.

In the invention, the debugging means includes trace data storage switching means for making available the storage means connected to the CPU not to be debugged in place of the trace memory as storage of the internal operation trace data, wherein the CPU not to be debugged is stopped in response to the free space of the trace memory and switches the storage of the internal operation trace data from the trace memory to the storage means connected to the CPU not to be debugged.

According to the described configuration, if the free space of the trace memory is out, the storage means of the stopped CPU not to be debugged can be used as the storage of the trace information, so that if the trace information exceeds the capacity of the trace memory, it is made possible to continue debugging without stopping the CPU and the frequency at which the CPU is stopped can be decreased without adding new trace memory and the debugging efficiency can be improved.

In the invention, the CPU not to be debugged includes trace data compression means for compressing the internal operation trace data stored in the storage means connected to the CPU not to be debugged.

According to the described configuration, to use the storage means of the stopped CPU not to be debugged as the storage of the trace information, the trace data stored in the storage means can be compressed, so that the transfer amount to the host computer having low transfer speed can be reduced.

According to the invention, there is provided a debugging apparatus for transmitting and receiving debug data between a host computer connected to a system LSI including a plurality of CPUs and a plurality of storage means connected to the CPUs and the selected CPU to be debugged from among the CPUs, the debugging apparatus including source address storage means for storing the source address of the CPU to be debugged set by the host computer, source CPU identifier storage means for storing the CPU identifier of the CPU to be debugged whose source address is set, destination address storage means for storing the destination address of the CPU to be debugged set by the host computer, destination CPU identifier storage means for storing the CPU identifier of the CPU to be debugged whose destination address is set, and debug data transfer means for transferring data between the host computer and the storage means connected to the CPU to be debugged indicated by the CPU identifier in accordance with the source address and the source CPU identifier or the destination address and the destination CPU identifier.

According to the described configuration, to transfer data between the CPU and the host computer, the CPU identifier can be used to identify the CPU of the data-transfer destination or the data transfer source, so that it is made possible to transfer data with one of the CPUs to be debugged selected even with one debugging apparatus, and the debugging circuit can be shared for reducing the number of debugging circuits.

According to the invention, there is provided a debugging apparatus for transmitting and receiving debug data to and from a host computer connected to a system LSI including a plurality of CPUs and a plurality of storage means connected to the CPUs, the debugging apparatus including debug object selection means being capable of selecting the CPU to be debugged from among the CPUs in accordance with a debug object selection request transmitted from the host computer and stopping any other CPU not to be debugged than the CPU to be debugged, source address storage means for storing the source address of the CPU to be debugged set by the host computer, destination address storage means for storing the destination address of the CPU to be debugged set by the host computer, and debug data transfer means for transferring data between the host computer and the storage means connected to the CPU to be debugged in accordance with the source address or the destination address.

According to the described configuration, one CPU to be debugged is selected by the host computer and the destination address or the source address is set, whereby data can be transferred between the storage means of the CPU to be debugged and the host computer, so that the debugging circuit can be shared and the number of debugging circuits can be reduced.

In the invention, the debugging apparatus further includes debug data CPU-to-CPU transfer means for transferring data between the storage means connected to the CPU to be debugged and the storage means connected to the CPU not to be debugged.

According to the described configuration, if one CPU to be debugged is selected and the CPU not to be debugged is stopped and the host computer sets the source address, first, data is transferred from the storage means of the CPU to be debugged to the storage means of the CPU not to be debugged and after completion of the data transfer, the transferred data can be transferred to the host computer. If the host computer sets the destination address, first, data is transferred from the host computer to the storage means of the CPU not to be debugged and after completion of the data transfer, the transferred data is transferred to the CPU to be debugged. Since the data transfer between the storage means of one CPU and that of another is executed at high speed as compared with the data transfer between the CPU and the host computer, the time occupying the bus by the CPU to be debugged can be shortened and the debugging efficiency can be improved.

According to the invention, in the system LSI made up of a plurality of CPUs, the CPUs can share the debugging circuit and only the CPU to be debugged, selected from the host computer can be debugged, so that it is made possible to reduce the area of the debugging circuit. Particularly, if debugging the CPUs operating in a dense coordinated fashion is not much required, means effective for reducing the area of the debugging circuit is provided.

### BRIEF DESCRIPTION OF THE DRAWINGS

FIG. 1 is a block diagram of a debugging apparatus according to a first embodiment of the invention;

FIG. 2 is a block diagram of a debugging apparatus according to a second embodiment of the invention;

FIG. 3 is a block diagram of a debugging apparatus according to a third embodiment of the invention;

FIG. 4 is a flowchart to show a processing procedure of event detection in the third embodiment of the invention;

FIG. 5 is a block diagram of a debugging apparatus according to a fourth embodiment of the invention;

FIG. 6 is a block diagram of a debugging apparatus according to a fifth embodiment of the invention;

FIG. 7 is a block diagram of a debugging apparatus according to a sixth embodiment of the invention;

FIG. 8 is a flowchart to show a procedure of trace data processing in the sixth embodiment of the invention;

FIG. 9 is a block diagram of a debugging apparatus according to a seventh embodiment of the invention;

FIG. 10 is a block diagram of a debugging apparatus according to an eighth embodiment of the invention;

FIG. 11 is a block diagram of a debugging apparatus according to a ninth embodiment of the invention;

FIG. 12 is a block diagram of a debugging apparatus according to a tenth embodiment of the invention; and

FIG. 13 is a flowchart to show a procedure of debug data processing in the tenth embodiment of the invention.

### DESCRIPTION OF THE PREFERRED EMBODIMENTS

Embodiments of debugging apparatus in a system LSI made up of a plurality of CPUs of the invention will be discussed with reference to the accompanying drawings.

### First Embodiment

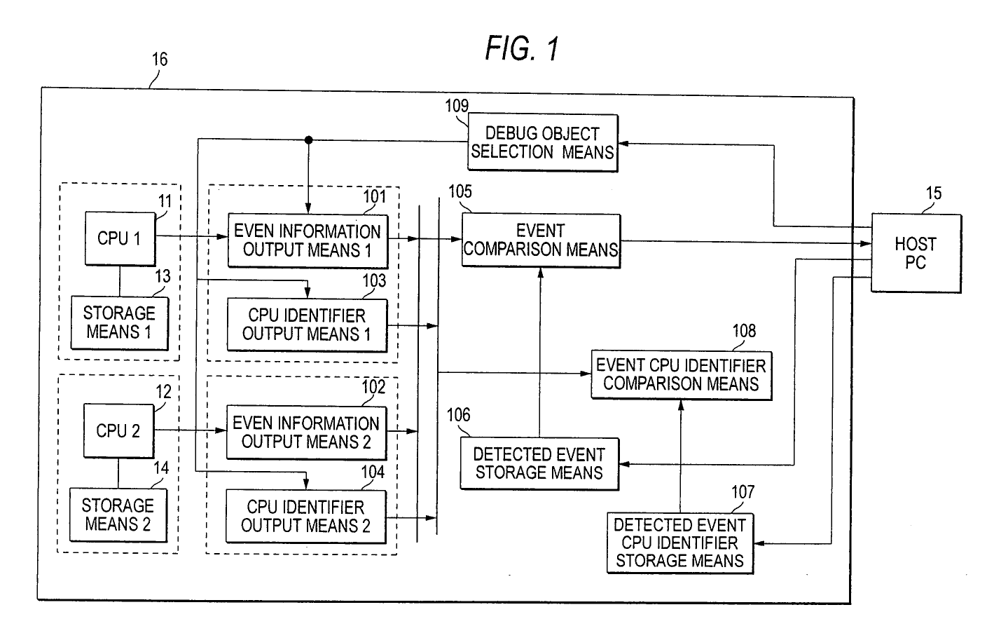

FIG. 1 is a block diagram of a debugging apparatus according to a first embodiment of the invention. In FIG. 1, a system LSI 116 is made up of a plurality of CPUs 11 and 12, storage means 13 and 14 connected to the CPUs 11 and 12 respectively, event information output means 101 and 102, CPU identifier output means 103 and 104, event comparison means 105, detected event storage means 106, detected event CPU identifier storage means 107, event CPU identifier comparison means 108, and debug object selection means 109, and is connected to a host PC 15 of a host computer.

Instructions executed by the CPU 11 and data used by the CPU 11 are stored in the storage means 13, and instructions executed by the CPU 12 and data used by the CPU 12 are stored in the storage means 14. The host PC 15 specifies the CPU to be debugged for the debug object selection means 109. Here, as the debug object, only the CPU 11, only the CPU 12, or either of the CPU 11 and the CPU 12 can be selected.

If the CPU 11 is selected by the debug object selection means 109, the CPU 11 outputs its operation information to the event comparison means 105 through the event information output means 101, and outputs the CPU identifier indicating the CPU 11 to the event CPU identifier comparison means 108.

Likewise, if the CPU 12 is selected by the debug object selection means 109, the CPU 12 outputs its operation information to the event comparison means 105 through the event information output means 102, and outputs the CPU identifier indicating the CPU 12 to the event identifier comparison means 108.

The host PC is stores the event to be detected in the detected event storage means 106 and stores the event CPU identifier to be detected in the detected event CPU identifier storage means 107.

The event CPU identifier comparison means 108 makes a comparison between the detected event identifier stored in the detected event CPU identifier storage means 107 and the output results of the CPU identifier output means 103 and 104.

If the detected event identifier stored in the detected event CPU identifier storage means 107 and the output result of the CPU identifier output means 103 match as the comparison result, the event comparison means 105 makes a comparison between the output results of the detected event storage means 106 and the event information output means 101 and outputs the comparison result to the host PC 15.

Likewise, if the detected event identifier stored in the detected event CPU identifier storage means 107 and the output result of the CPU identifier output means 104 match, the event comparison means 105 makes a comparison between the output results of the detected event storage means 106 and the event information output means 102 and outputs the comparison result to the host PC 15.

The debugging apparatus is configured as described above, whereby the host PC can set the event to be detected and the CPU identifier to be detected and the CPU is identified according to the CPU identifier output in the event information output comparison, so that it is made possible to debug a plurality of CPUs at the same time using one debugging resource, and the area of the debugging resource on the system LSI can be reduced.

### Second Embodiment

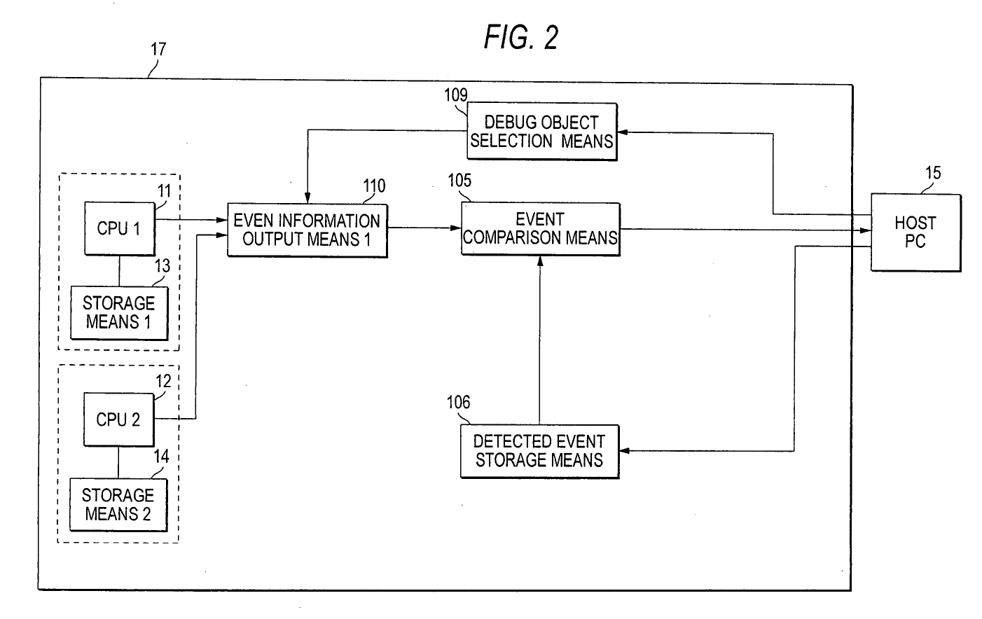

FIG. 2 is a block diagram of a debugging apparatus according to a second embodiment of the invention. In FIG. 2, a system LSI 117 is made up of a plurality of CPUs 11 and 12, storage means 13 and 14 connected to the CPUs 11 and 12 respectively, event information output means 110, debug object selection means 109, event comparison means 105, and detected event storage means 106, and is connected to a host PC 15.

The host PC 15 specifies the CPU to be debugged for the debug object selection means 109. The debug object is only the CPU 11 or only the CPU 12 and a plurality of CPUs cannot be selected at the same time. The debug object selection means 109 notifies the event information output means 110 of the CPU to be debugged.

If the debug object is the CPU 11, the event information output means 110 outputs the internal operation event of the CPU 11 to the event comparison means 105; if the debug object is the CPU 12, the event information output means 110 outputs the internal operation event of the CPU 12 to the event comparison means 105.

The host PC 15 previously stores the event to be detected in the detected event storage means 106.

The event comparison means 105 makes a comparison between an event output from the event information output means 110 and the event stored in the detected event storage means 106 and if they match, notifies the host PC 15 of event detection.

The debugging apparatus is configured as described above, whereby in the system LSI installing a plurality of CPUs, one CPU can be debugged as the debug object in a state in which two or more CPUs operate at the same time, and it is made possible to share the debugging circuit. Although a plurality of CPUs can be debugged at the same time in the first embodiment, one CPU only can be debugged at a time in the second embodiment, but the host PC need not specify the CPU identifier, so that the traffic with the host PC can be decreased.

### Third Embodiment

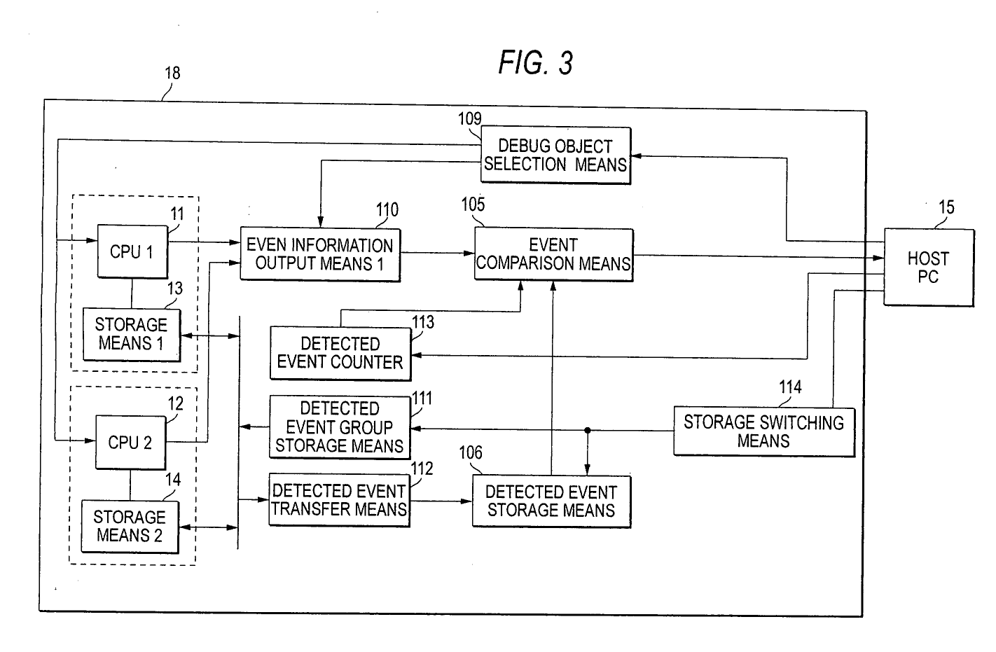

FIG. 3 is a block diagram of a debugging apparatus according to a third embodiment of the invention. In FIG. 3, a system LSI 118 is made up of a plurality of CPUs 11 and 12, storage means 13 and 14 connected to the CPUs 11 and 12 respectively, event information output means 110, detected event group storage means 111, a detected event counter 113, debug object selection means 109, detected event storage means 106, event comparison means 105, detected event transfer means 112, and event storage switching means 114, and is connected to a host PC 15.

The host PC 15 notifies the debug object selection means 109 of the CPU to be debugged. As the debug object, only the CPU 11 or only the CPU 12 can be selected. At the same time, exclusive debugging can be selected. To select the CPU 11 as the debug object and debug the CPU 11 exclusively, the CPU 12 is stopped; to select the CPU 12 as the debug object and debug the CPU 11 exclusively, the CPU 11 is stopped.

If the CPU 31 is selected as the debug object, the event information output means 110 outputs the internal operation event of the CPU 11 to the event comparison means 105; if the CPU 12 is selected as the debug object, the event information output means 110 outputs the internal operation event of the CPU 12 to the event comparison means 105.

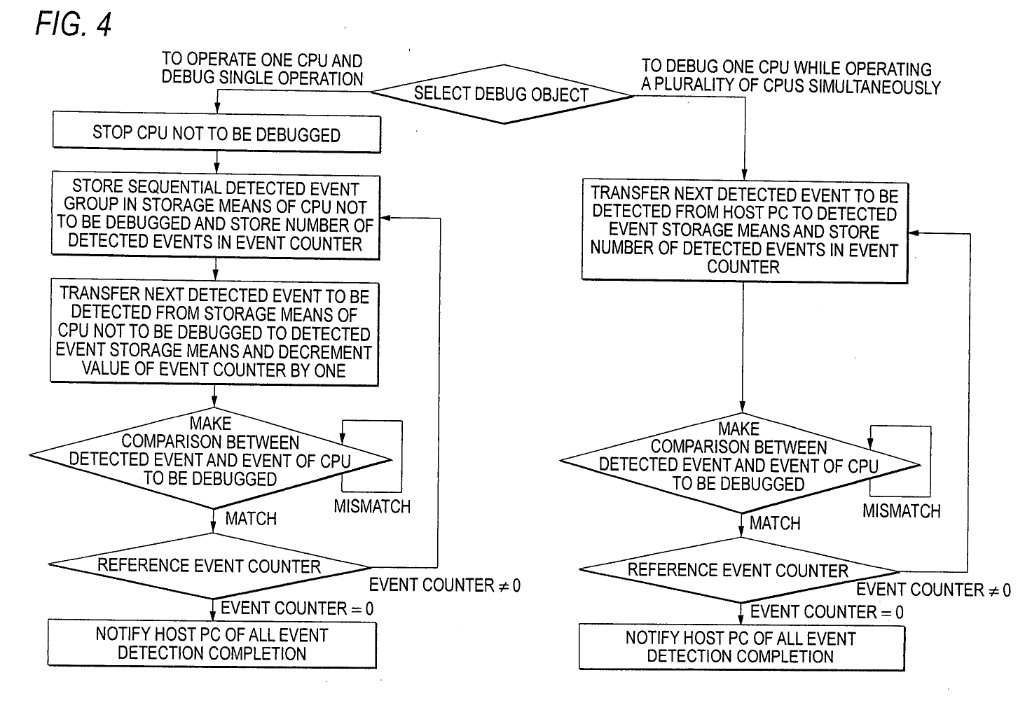

FIG. 4 is a flowchart to show a processing procedure of event detection in the embodiment of the invention. In FIG. 4, if exclusive debugging is selected, the host PC 15 stores the event to be detected in the storage means of the CPU not to be debugged by the detected event group storage means 111.

If the events to be detected are an event group having a plurality of orders, the event group is stored in the storage means of the CPU not to be debugged, and the number of events is stored in the detected event counter 113. The detected event transfer means 112 transfers the first detected event from the detected event group stored in the storage means of the CPU not to be debugged to the detected event storage means 106 and decrements the detected event counter 113 by one.

The event comparison means 105 makes a comparison between the internal operation event output by the event information output means 110 and the event stored in the detected event storage means 106. When they match, if the value of the detected event counter 113 is 0, the event comparison means 105 notifies the host PC 15 of event detection.

If the value of the detected event counter 113 is not 0, the detected event transfer means 112 transfers the next detected event from the detected event group stored in the storage means of the CPU not to be debugged to the detected event storage means 106 and decrements the detected event counter 113 by one.

If exclusive debugging is not selected, the host PC 15 stores the first detected event in the event group to be detected in the detected event storage means 106. If the events to be detected are an event group having a plurality of orders, the number of detected events is decremented by one and the result value is stored in the detected event counter 113.

The event comparison means 105 makes a comparison between the internal operation event output by the event information output means 110 and the event stored in the detected event storage means 106. When they match, if the value of the detected event counter 113 is 0, the event comparison means 105 notifies the host PC 15 of event detection. If the value of the detected event counter 113 is not 0, the host PC 15 stores the next detected event in the detected event storage means 106 and decrements the detected event counter 113 by one.

The debugging apparatus is configured as described above, whereby in the system LSI installing a plurality of CPUs, to debug a single CPU, the debugging circuit can be shared and the area can be reduced and further to debug the exclusive operation, the CPU not to be debugged is stopped and the storage means of the CPU is used as storage of a plurality of detected events, so that even if the capacity of the detected event storage means is small, whenever an event is detected, it is made possible to debug without waiting for transfer of the detected event from the host PC, and the real-time property improves.

### Fourth Embodiment

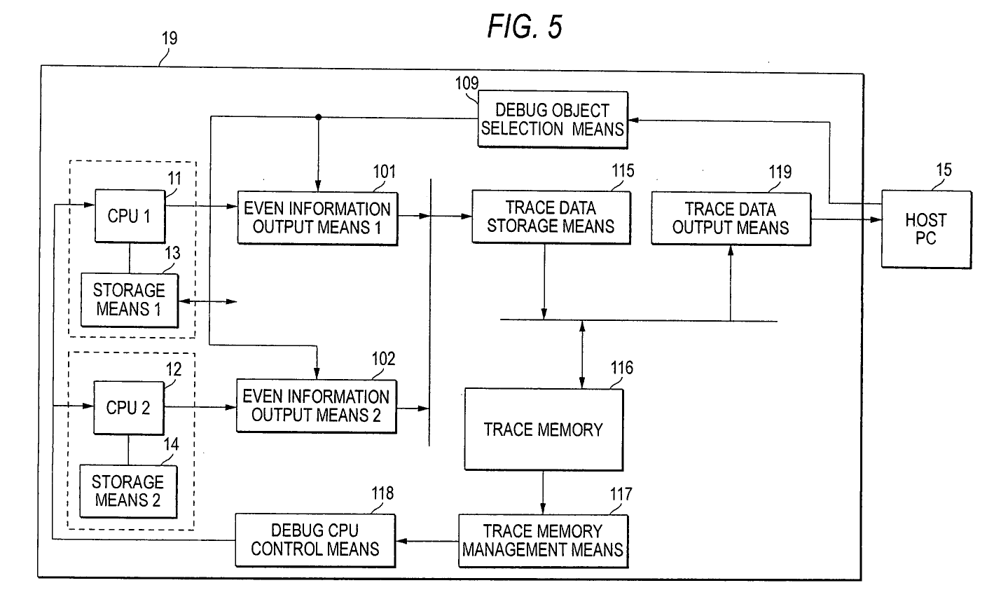

FIG. 5 is a block diagram of a debugging apparatus according to a fourth embodiment of the invention. In FIG. 5, a system LSI 119 is made up of a plurality of CPUs 11 and 12, storage means 13 and 14 connected to the CPUs 11 and 12 respectively, event information output means 101 and 102 connected to the CPUs 11 and 12 respectively, debug CPU control means 118, debug object selection means 109, trace data storage means 115, trace memory 116, trace memory management means 117, and trace data output means 119, and is connected to a host PC 15.

The host PC 15 notifies the debug object selection means 109 of the CPU to be debugged. As the debug object, only the CPU 11, only the CPU 12, or either of the CPU 11 and the CPU 12 can be selected.

If the CPU 11 is selected by the debug object selection means 109, the CPU 11 outputs operation information of the CPU 11 to the trace data storage means 115 through the event information output means 101. If the CPU 12 is selected by the debug object selection means 109, the CPU 12 outputs trace data to the trace data storage means 115 through the event information output means 102.

The trace data storage means 115 divides the trace memory 116 into as many areas as the number of the CPUs to be debugged and stores the trace data in the areas corresponding to the CPUs to be debugged.

The trace data output means 119 outputs the trace data stored in the trace memory 116 to the host PC 15. The trace memory management means 117 monitors the free space of the trace memory 116 and it the free space is out, the trace memory management means 117 notifies the debug CPU control means 118 that the free space is out for stopping the CPU 11, the CPU 12.

The debugging apparatus is configured as described above, whereby it is made possible to debug a plurality of CPUs at the same time using one debugging resource, and the circuit area can be reduced.

### Fifth Embodiment

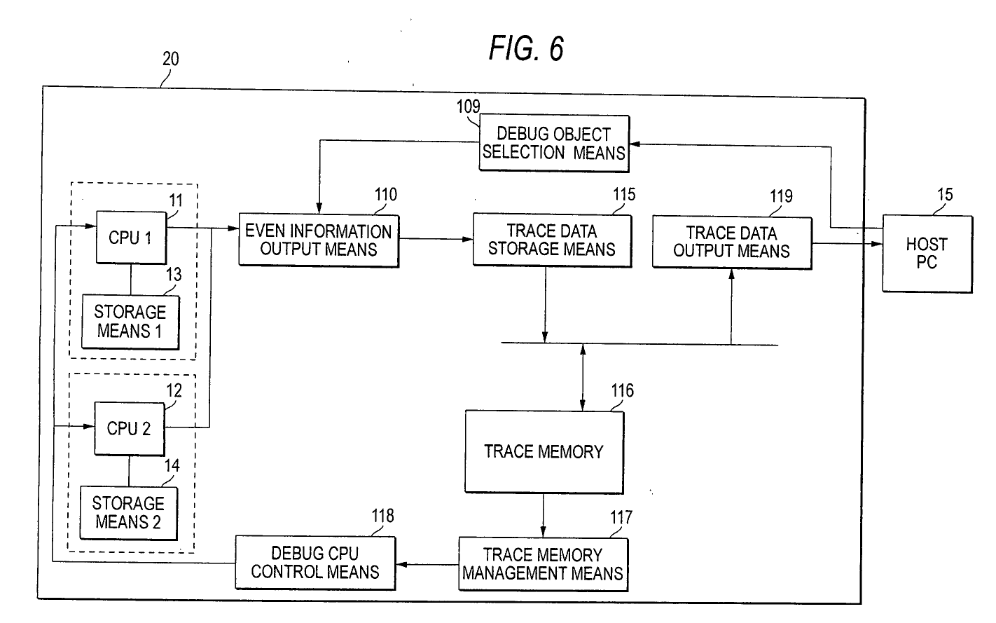

FIG. 6 is a block diagram of a debugging apparatus according to a fifth embodiment of the invention. In FIG. 6, a system LSI 120 is made up of a plurality of CPUs 11 and 12, storage means 13 and 14 connected to the CPUs 11 and 12 respectively, event information output means 110, debug CPU control means 118, debug object selection means 109, trace data storage means 115, trace memory 116, trace memory management means 117, and trace data output means 119, and is connected to a host PC 15.

The host PC 15 notifies the debug object selection means 109 of the CPU to be debugged. As the debug object, only the CPU 11 or only the CPU 12 can be selected. The debug object selection means 109 notifies the event information output means 110 of the CPU to be debugged

The event information output means 110 outputs the internal operation event of the CPU to be debugged that the debug object selection means 109 notifies the event information output means 110 of, to the trace data storage means 115. The trace data storage means 115 stores the internal operation event in the trace memory 116.

The trace memory management means 117 monitors the free space of the trace memory 116 and if the free space is out, the trace memory management means 117 notifies the debug CPU control means 118 that the free space is out for stopping the CPU. The trace data output means 119 outputs the data stored in the trace memory 116 to the host PC 15.

The debugging apparatus is configured as described above, whereby in the system LSI installing a plurality of CPUs, one CPU can be debugged in a state in which two or more CPUs operate at the same time, and it is made possible to share the debugging circuit.

### Sixth Embodiment

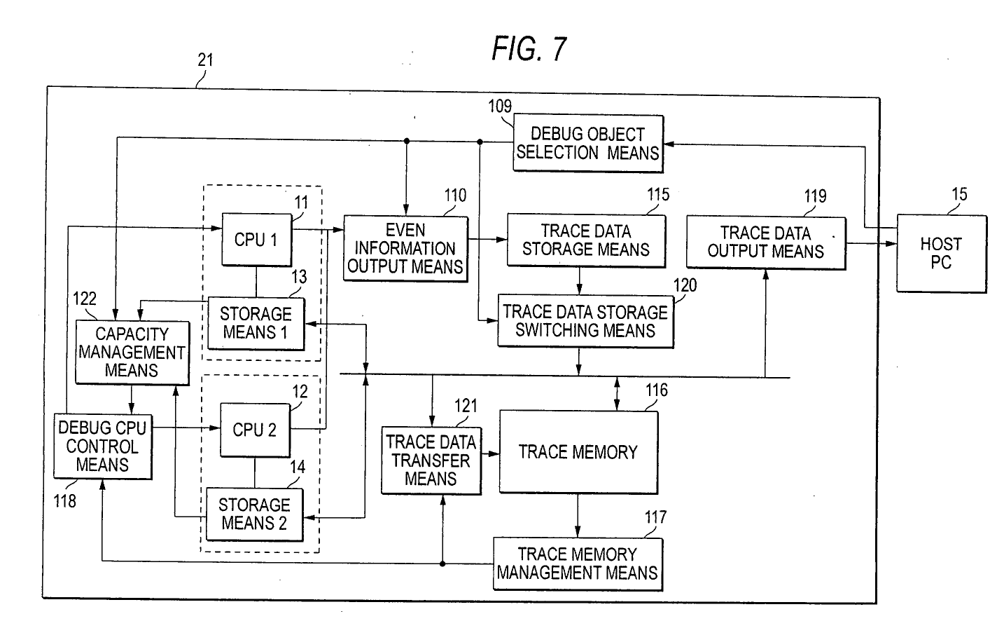

FIG. 7 is a block diagram of a debugging apparatus according to a sixth embodiment of the invention. In FIG. 7, a system LSI 121 is made up of a plurality of CPUs 11 and 12, storage means 13 and 14 connected to the CPUs 11 and 12 respectively, event information output means 110, debug CPU control means 118, debug object selection means 109, trace data storage means 115, trace data storage switching means 120, trace memory 116, trace memory management means 117, trace data output means 119, trace data transfer means 121, and capacity management means 122, and is connected to a host PC 15.

The host PC 15 notifies the debug object selection means 109 of the CPU to be debugged. As the debug object, only the CPU 11 or only the CPU 12 can be selected, and exclusive debugging can be selected. If exclusive debugging is selected, the debug object selection means 109 stops the CPU not to be debugged.

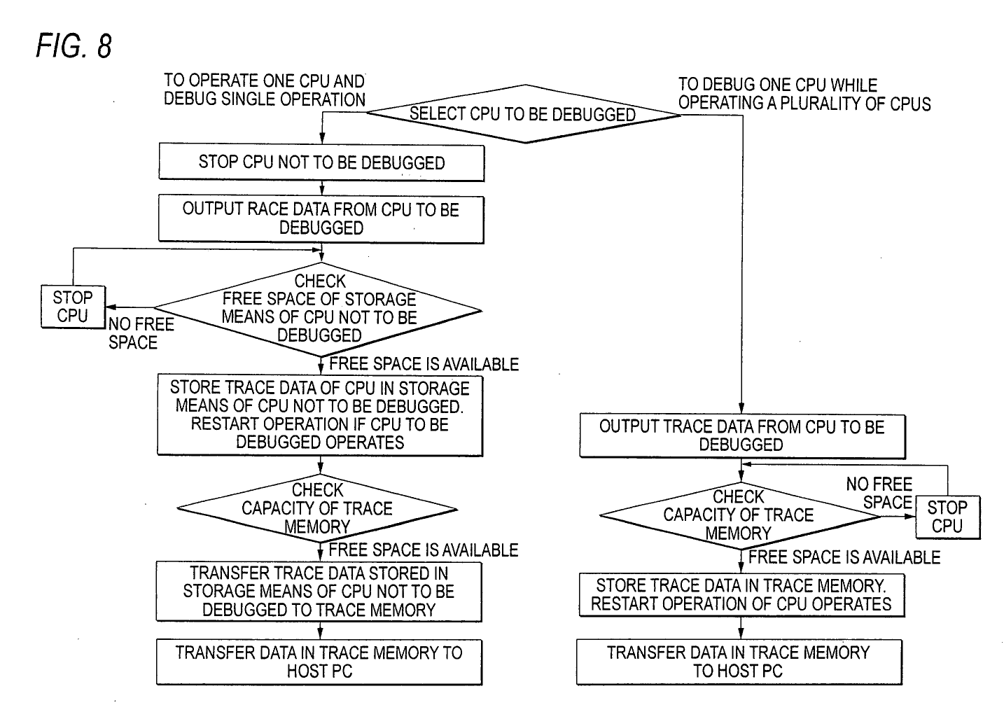

FIG. 8 is a flowchart of trace data processing in the embodiment of the invention. In FIG. 8, to perform exclusive debugging, the event information output means 110 outputs the internal operation event of the CPU to be debugged that the debug object selection means 109 notifies the event information output means 110 of, to the trace data storage means 115.

Storage of trace data is changed by the trace data storage switching means 120 to the storage means of the CPU not to be debugged. The free space of the storage means of the CPU not to be debugged is monitored by the capacity management means 122 and if the free space is out, the capacity management means 122 notifies the debug CPU control means 118 that the free space is out. The debug CPU control means 118 stops the operation of the CPU and if a free space is available, restarts the operation of the CPU.

The trace data stored in the storage means of the CPU not to be debugged is transferred to the trace memory 116 by the trace data transfer means 121. The free space of the trace memory 116 is monitored by the trace memory management means 117 and if the free space is out, transfer of the trace data from the storage means is not executed. The trace data stored in the trace memory 116 is output to the host PC 15 by the trace data output means 119.

If exclusive debugging is not performed, the event information output means 110 outputs the internal operation event of the CPU to be debugged that the debug object selection means. 109 notifies the event information output means 110 of, to the trace data storage means 115. Storage of the trace data is set in the trace memory 116 by the trace data storage switching means 120.

The free space of the trace memory 116 is monitored by the trace memory management means 117 and if the free space is out, the trace memory management means 117 notifies the debug CPU control means 118 that the free space is out. The debug CPU control means 118 stops the CPU and if a free space is available, restarts the operation of the CPU. The trace data stored in the trace memory 116 is output to the host PC 15 by the trace data output means 119.

The debugging apparatus is configured as described above, whereby in the system LSI installing a plurality of CPUs, to debug a single CPU, the CPU not to be debugged is stopped and the storage means of the CPU is used as the storage of the trace data, so that the capacity of the trace memory is small, a larger number of pieces of data can be stored and thus the frequency at which the CPU stops due to the fact that it becomes impossible to store the trace data is decreased and the debugging efficiency is enhanced.

### Seventh Embodiment

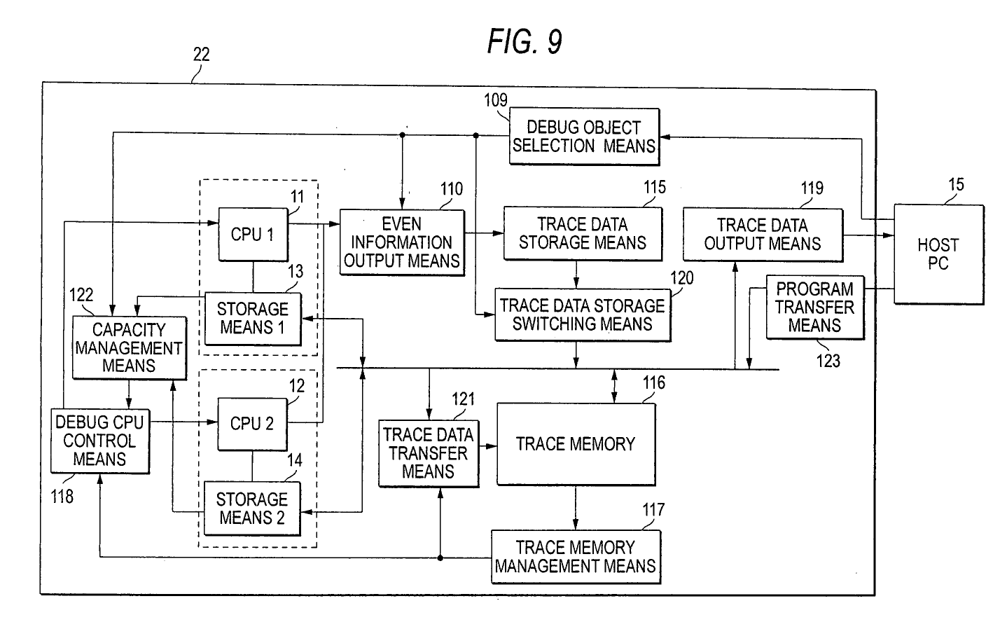

FIG. 9 is a block diagram of a debugging apparatus according to a seventh embodiment of the invention. In FIG. 9, a system LSI 122 is made up of a plurality of CPUs 11 and 12, storage means 13 and 14 connected to the CPUs 11 and 12 respectively, event information output means 110, debug CPU control means 118, debug object selection means 109, trace data storage means 115, trace data storage switching means 120, trace memory 116, trace memory management means 117, trace data output means 119, trace data transfer means 121, capacity management means 122, and program transfer means 123, and is connected to a host PC 15.

The host PC 15 notifies the debug object selection means 109 of the CPU to be debugged. As the debug object, only the CPU 11 or only the CPU 12 can be selected, and exclusive debugging can be selected. If exclusive debugging is selected, the debug object selection means 109 stops the CPU not to be debugged.

To perform exclusive debugging, the program transfer means 123 transfers a trace memory compression program to the storage means of the CPU not to be debugged. The event information output means 110 outputs the internal operation event of the CPU to be debugged that the debug object selection means 109 notifies the event information output means 110 of, to the trace data storage means 115.

Storage of the trace data is changed to the storage means of the CPU not to be debugged by the trace data storage switching means 120. The CPU not to be debugged uses the trace memory compression program transferred to the storage means to compress the trace data in the storage means.

The free space of the storage means of the CPU not to be debugged is monitored by the capacity management means 122 and if the free space is out, the capacity management means 122 notifies the debug CPU control means 118 that the free space is out. The debug CPU control means 118 stops the operation of the CPU and if a free space is available, restarts the operation of the CPU.

The trace data stored in the storage means of the CPU not to be debugged is transferred to the trace memory 116 by the trace data transfer means 121. The free space of the trace memory 116 is monitored by the trace memory management means 117 and if the free space is out, transfer of the trace data from the storage means is not executed. The trace data stored in the trace memory 116 is output to the host PC 15 by the trace data output means 119.

If exclusive debugging is not performed, the event information output means 110 outputs the internal operation event of the CPU to be debugged that the debug object selection means 109 notifies the event information output means 110 of, to the trace data storage means 115. Storage of the trace data is set in the trace memory 116 by the trace data storage switching means 120.

The free space of the trace memory 116 is monitored by the trace memory management means 117 and if the free space is out, the trace memory management means 117 notifies the debug CPU control means 118 that the free space is out. The debug CPU control means 118 stops the CPU and if a free space is available, restarts the operation of the CPU. The trace data stored in the trace memory 116 is output to the host PC 15 by the trace data output means 119.

The debugging apparatus is configured as described above, whereby in the system LSI installing a plurality of CPUs, to debug a single CPU, the CPU not to be debugged is stopped and the storage means of the CPU is used as the storage of the trace data, so that the capacity of the trace memory is small, a larger number of pieces of data can be stored and thus the frequency at which the CPU stops due to the fact that it becomes impossible to store the trace data is decreased and the debugging efficiency is enhanced. As the trace data is compressed, the communication amount with the host PC can be reduced.

### Eighth Embodiment

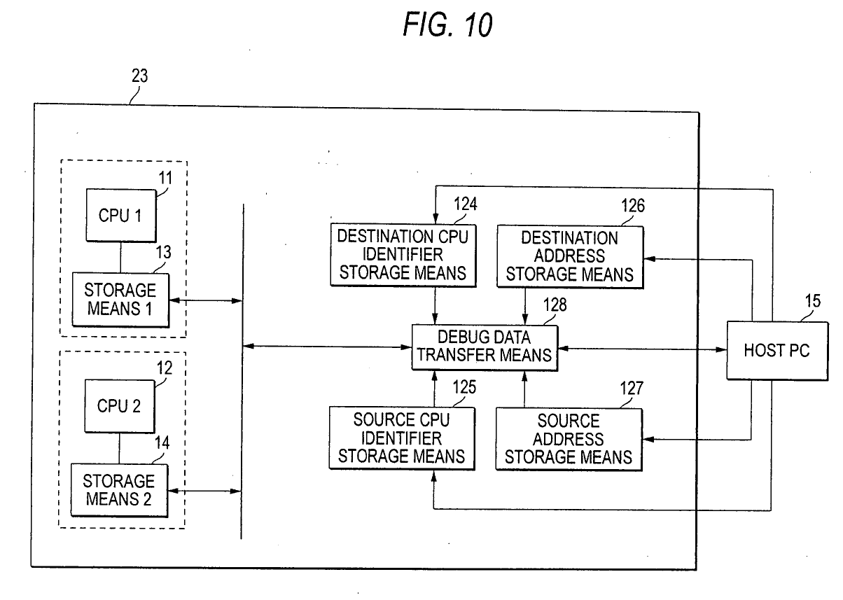

FIG. 10 is a block diagram of a debugging apparatus according to an eighth embodiment of the invention. In FIG. 10, a system LSI 23 is made up of a plurality of CPUs 11 and 12, storage means 13 and 14 connected to the CPUs 11 and 12 respectively, destination CPU identifier storage means 124, source CPU identifier storage means 125, destination address storage means 126, source address storage means 127, and debug data transfer means 128, and is connected to a host PC 15.

The host PC 15 stores the CPU identifier indicating the destination CPU in the destination CPU identifier storage means 124, the destination address in the destination address storage means 126, the CPU identifier indicating the source CPU in the source CPU identifier storage means 125, and the source address in the source address storage means 127.

Upon reception of a transfer request from the host PC 15, the debug data transfer means 128 transfers data from the storage means of the CPU indicated by the contents of the source CPU identifier storage means 125 and the source address storage means 127 to the host PC 15 or transfers data from the host PC 15 to the storage means of the CPU indicated by the contents of the destination CPU identifier storage means 124 and the destination address storage means 126.

The debugging apparatus is configured as described above, whereby in the system LSI installing a plurality of CPUs, a plurality of CPUs can be debugged at the same time in a state in which two or more CPUs operate at the same time, and the debugging circuit can be shared, so that it is made possible to reduce the area of the debugging circuit.

### Ninth Embodiment

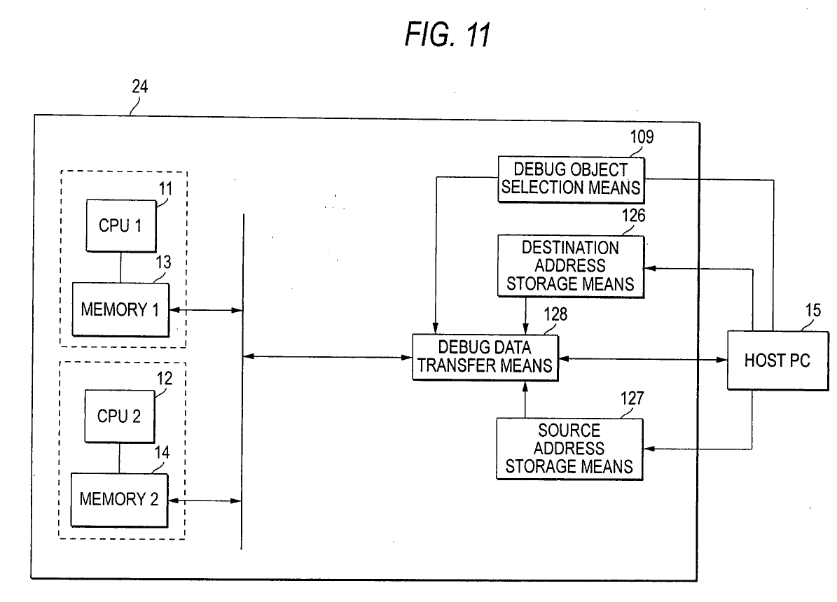

FIG. 11 is a block diagram of a debugging apparatus according to a ninth embodiment of the invention. In FIG. 11, a system LSI 24 is made up of a plurality of CPUs 11 and 12, storage means 13 and 14 connected to the CPUs 11 and 12 respectively, debug object selection means 109, destination address storage means 126, source address storage means 127, and debug data transfer means 128, and is connected to a host PC 15.

The host PC 15 notifies the debug object selection means 109 of the CPU to be debugged. As the debug object, only the CPU 11 or only the CPU 12 can be set.

The host PC 15 stores the destination address in the destination address storage means 126 and the source address in the source address storage means 127.

Upon reception of a transfer request from the host PC 15, the debug data transfer means 128 transfers data from the source address stored in the source address storage means 127 to the host PC 15 or transfers data from the host PC 15 to the destination address stored in the destination address storage means 126 between the storage means of the CPU to be debugged selected by the debug object selection means 109 and the host PC 15.

The debugging apparatus is configured as described above, whereby in the system LSI installing a plurality of CPUs, one CPU can be debugged in a state in which two or more CPUs operate at the same time.

### Tenth Embodiment

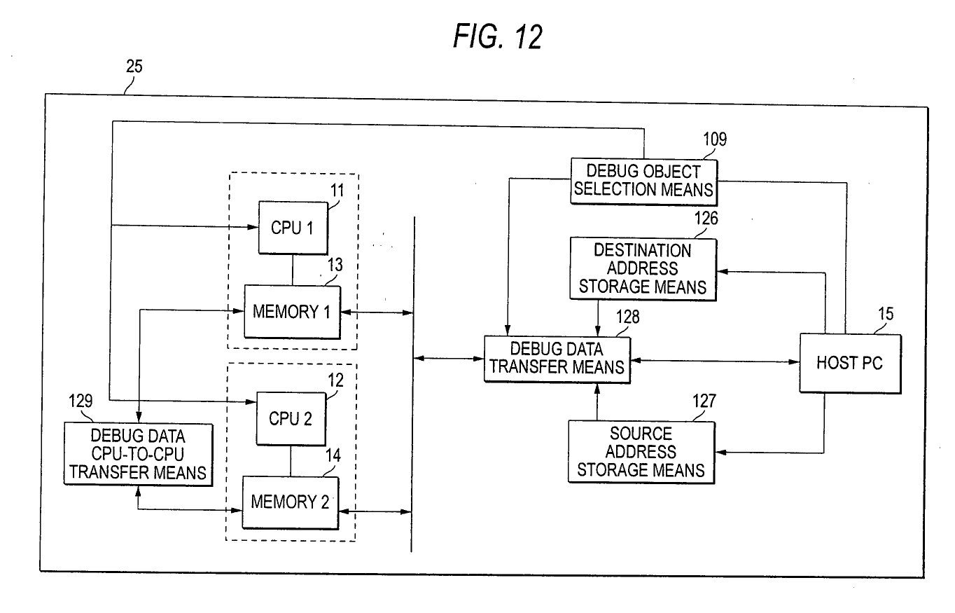

FIG. 12 is a block diagram of a debugging apparatus according to a tenth embodiment of the invention. In FIG. 12, a system LSI 25 is made up of a plurality of CPUs 11 and 12, storage means 13 and 14 connected to the CPUs 11 and 12 respectively, debug data CPU-to-CPU transfer means 129, destination address storage means 126, source address storage means 127, debug data transfer means 128, and debug object selection means 109, and is connected to a host PC 15.

The host PC 15 notifies the debug object selection means 109 of the CPU to be debugged. As the debug object, only the CPU 1 or only the CPU 2 can be selected. Exclusive debugging can also be selected.

To perform exclusive debugging, the debug object selection means 109 stops the CPU not to be debugged. The host PC 15 stores the destination address in the destination address storage means 126 and the source address in the source address storage means 127.

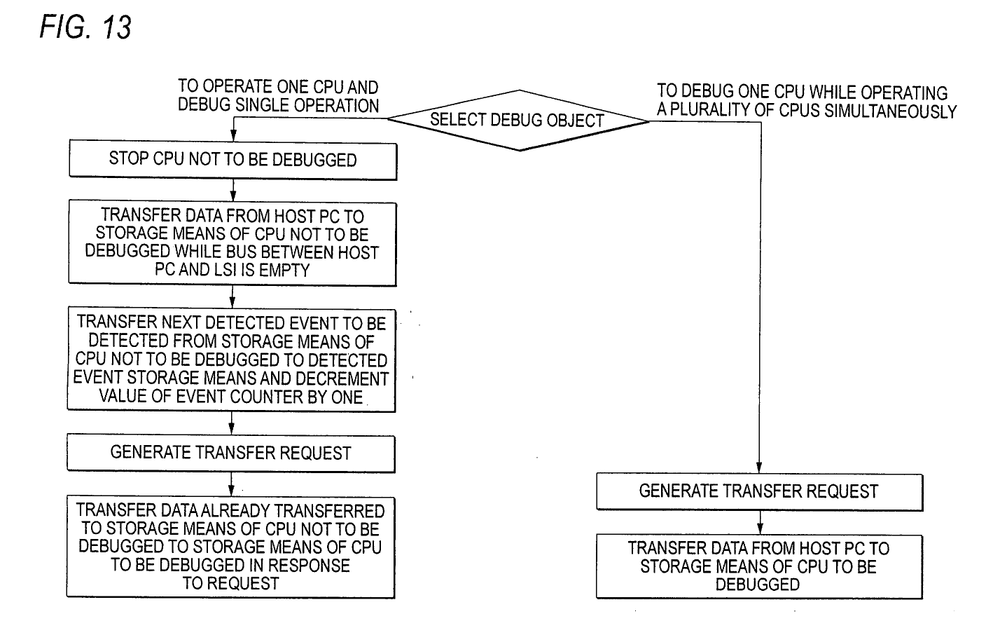

FIG. 13 is a flowchart of debug data processing in the embodiment of the invention. In FIG. 13, to transfer data from the host PC 15 to the storage means of the CPU to be debugged, the debug data transfer means 128 once transfers the data from the host PC 15 to the storage means of the CPU not to be debugged. Upon reception of a transfer request from the host PC 15, the debug data CPU-to-CPU transfer means 129 transfers the data from the storage means of the CPU not to be debugged to the storage means of the CPU to be debugged.

To transfer data from the storage means of the CPU to be debugged to the host PC 15, the debug data CPU-to-CPU transfer means 129 transfers the data from the storage means of the CPU to be debugged to the storage means of the CPU not to be debugged. Upon reception of a transfer request from the host PC 15, the debug data transfer means 128 transfers the data already transferred to the storage means of the CPU not to be debugged to the host PC 15.

If exclusive debugging is not performed, the host PC 15 stores the destination address in the destination address storage means 126 and the source address in the source address storage means 127. Upon reception of a transfer request from the host PC 15, the debug data transfer means 128 transfers data from the source address stored in the source address storage means 127 to the host PC 15 or transfers data from the host PC 15 to the destination address stored in the destination address storage means 126 between the storage means of the CPU to be debugged selected by the debug object selection means 109 and the host PC 15.

The debugging apparatus is configured as described above, whereby in the system LSI installing a plurality of CPUs, to debug a single CPU, the CPU not to be debugged is stopped and the storage means of the CPU is used as the temporary storage of the transfer data, so that data communications with the host PC need not be performed in real time and it is made possible to decrease the frequency at which the operation of the CPU is made to wait.

What is claimed is:

1. A debugging apparatus for transmitting and receiving debug data to and from a host computer connected to a system LSX comprising a plurality of CPUs and a plurality of storage means connected to the CPUs, said debugging apparatus comprising:
debug object selection means being capable of selecting the CPU to be debugged from among the CPUs in accordance with a debug object selection request transmitted from the host computer and stopping any other CPU not to be debugged than the CPU to be debugged and debugging means for debugging the CPU to be debugged in accordance with debug data transmitted from the host computer and transmitting the debug result to the host computer.

2. The debugging apparatus as claimed in claim 1 wherein said debugging means comprises a plurality of event information output means being connected to the CPUs for outputting internal event information of the CPU to be debugged, a plurality of CPU identifier output means being connected to the CPUs each for outputting a CPU identifier of the CPU, detected event storage means for temporarily storing a detected event set by the host computer, detected event CPU identifier storage means for storing a detected event CPU identifier set by the host computer, detected event CPU identifier comparison means for making a comparison between the CPU identifier and the detected event CPU identifier to detect a match therebetween, and event comparison means for making a comparison between the internal event information of the CPU indicated by the CPU identifier when the detected event CPU identifier comparison means detects a match and the detected event to detect a match therebetween.

3. The debugging apparatus as claimed in claim 1 wherein said debugging means comprises event information output means being connected to all CPUs for outputting internal event information of one selected CPU to be debugged, detected event storage means for temporarily storing a detected event set by the host computer, and event comparison means for making a comparison between the internal event information and the detected event to detect a match therebetween.

4. The debugging apparatus as claimed in claim 3 wherein said debugging means further comprises detected event group storage means, if the detected events set by the host computer are a plurality of sequential detected events, the detected event group storage means for storing the detected events exceeding the capacity of the detected event storage means in the storage means connected to the CPU not to be debugged in the execution order, detected event transfer means for transferring the detected events in the execution order from the detected event group stored in the storage means connected to the CPU not to be debugged to the detected event storage means if the event comparison means detects a match, and a detected event counter for counting the number of matches detected by the event comparison means and if the detected events set by the host computer are all detected, notifying the host computer that event detection is complete.

5. The debugging apparatus as claimed in claim 1 wherein said debugging means comprises a plurality of event information output means being connected to the CPUs for outputting internal event information of the CPU to be debugged, trace memory for storing the internal operation trace data of the CPU to be debugged, trace data storage means for generating the internal operation trace data from the internal event information and storing the internal operation trace data in the trace memory as the trace memory is divided into areas in the CPU units, trace data output means for outputting the internal operation trace data stored in the trace memory to the host computer, trace memory management means for managing a free space of the trace memory, and debug CPU control means for controlling temporary stop and operation restart of the CPU to be debugged in response to the free space of the trace memory.

6. The debugging apparatus as claimed in claim 1 wherein said debugging means comprises event information output means being connected to all CPUs for outputting internal event information of one selected CPU to be debugged, trace memory for storing the internal operation trace data of the CPU to be debugged, trace data storage means for generating the internal operation trace data from the internal event information and storing the internal operation trace data in the trace memory as the trace memory is divided into areas in the CPU units, trace data output means for outputting the internal operation trace data stored in the trace memory to the host computer, trace memory management means for managing a free space of the trace memory, and debug CPU control means for controlling temporary stop and operation restart of the CPU to be debugged in response to the free space of the trace memory.

7. The debugging apparatus as claimed in claim 6 wherein said debugging means comprises trace data storage switching means for making available the storage means connected to the CPU not to be debugged in place of the trace memory as storage of the internal operation trace data, wherein the CPU not to be debugged is stopped in response to the free space of the trace memory and switches the storage of the internal operation trace data from the trace memory to the storage means connected to the CPU not to be debugged.

8. The debugging apparatus as claimed in claim 7 wherein the CPU not to be debugged comprises trace data compression means for compressing the internal operation trace data stored in the storage means connected to the CPU not to be debugged.

9. A debugging apparatus for transmitting and receiving debug data between a host computer connected to a system LSI comprising a plurality of CPUs and a plurality of storage means connected to the CPUs and the selected CPU to be debugged from among the CPUs, said debugging apparatus comprising:
source address storage means for storing a source address of the CPU to be debugged set by the host computer, source CPU identifier storage means for storing the CPU identifier of the CPU to be debugged whose source address is set, destination address storage means for storing a destination address of the CPU to be debugged set by the host computer, destination CPU identifier storage means for storing the CPU identifier of the CPU to be debugged whose destination address is set, and debug data transfer means for transferring data between the host computer and the storage means connected to the CPU to be debugged indicated by the CPU identifier in accordance with the source address and the source CPU identifier or the destination address and the destination CPU identifier.

10. A debugging apparatus for transmitting and receiving debug data to and from a host computer connected to a system LSI comprising a plurality of CPUs and a plurality of storage means connected to the CPUs, said debugging apparatus comprising:
debug object selection means being capable of selecting the CPU to be debugged from among the CPUs in accordance with a debug object selection request transmitted from the host computer and stopping any other CPU not to be debugged than the CPU to be debugged, source address storage means for storing a source address of the CPU to be debugged set by the host computer, destination address storage means for storing a destination address of the CPU to be debugged set by the host computer, and debug data transfer means for transferring data between the host computer and the storage means connected to the CPU to be debugged in accordance with the source address or the destination address.

11. The debugging apparatus as claimed in claim 10 further comprising debug data CPU-to-CPU transfer means for transferring data between the storage means connected to the CPU to be debugged and the storage means connected to the CPU not to be debugged.
